(19) United States
(12) Patent Application Publication
(10) Pub. No.: US 2006/0039596 A1
(43) Pub. Date: Feb. 23, 2006

(54) Pattern measuring method, pattern measuring apparatus, photo mask manufacturing method, semiconductor device manufacturing method, and computer program product

(76) Inventors: Shigeki Nojima, Yokohama-shi (JP); Hiroshi Motoki, Yokohama-shi (JP); Takahiro Ikeda, Yokohama-shi (JP); Satoshi Tanaka, Kawasaki-shi (JP); Takeshi Ito, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/205,017

(22) Filed: Aug. 17, 2005

(30) Foreign Application Priority Data
Aug. 18, 2004 (JP) 2004-238535

(51) Int. Cl. G06K 9/00

(52) U.S. Cl. 382/144

(57) ABSTRACT

A pattern measuring method includes preparing a substrate comprising a pattern, extracting a place to be measured on the substrate based on a simulation using pattern data relating to the pattern as input data, generating measurement information for measuring a physical quantity of the place to be measured by a measuring apparatus, and measuring the place to be measured based on the measurement information by the measuring apparatus.

### CROSS-REFERENCE TO RELATED APPLICATIONS

This application is based upon and claims the benefit of priority from prior Japanese Patent Application No. 2004-238535, filed Aug. 18, 2004, the entire contents of which are incorporated herein by reference.

### BACKGROUND OF THE INVENTION

1. Field of the Invention

The present invention relates to a pattern measuring method for a pattern formed on a substrate such as a semiconductor wafer or the like, a pattern measuring apparatus, a photo mask manufacturing method, a semiconductor device manufacturing method, and a computer program product.

2. Description of the Related Art

The progress in the semiconductor manufacturing technology in recent years is extremely remarkable, and semiconductor device having a size minimum of 70 nm is produced in large quantities. The miniaturization of semiconductor device is realized by rapid progress in fine pattern forming technology such as a mask process technology, an optical lithography technology, an etching technology, and the like.

In the days when pattern sizes have been sufficiently large, a pattern nearly same as the design pattern can be formed on the wafer by drawing a plane shape of a desired integrated circuit as a design pattern on a mask pattern, preparing a mask pattern which is faithful to the design pattern, transferring the mask pattern on the wafer by a projective optical system, and etching an underlying layer.

However, as the miniaturization of semiconductor device and integration of integrated circuit increase, forming the pattern faithfully is getting difficult in each process. As a result, the problem that a final finished dimension is not made to be as the same as a design pattern has been brought about.

One of the reasons for the above-described problem is that a layout disposition of other patterns disposed at the periphery of a desired pattern greatly affects a dimensional precision of the desired pattern in lithography and etching processes which are most important for achieving fine processing.

Then, mask correction technologies such as an optical proximity correction (OPC) and a process proximity correction (PPC) is developed in order to avoid those influences.

The aforementioned mask correction technologies are to add an auxiliary pattern in advance such that a dimension after processing is made to be a design pattern (desired value), or to make a width of a pattern broad or narrow (Jpn. Pat. Appln. KOKAI Publication Nos. 09-319067 and 2003-107664, SPIE Vol. 2322 (1994) 374 (Large Area Optical Proximity Correction using Pattern Based Correction, D. M. Newmark et. al). In accordance therewith, it is possible to form an integrated circuit pattern which a designer has drawn on a wafer.

When the mask correction technologies are used, a technology for verifying validity of the correction is required. As the most effective method for evaluating the validity, there is a method which measures a pattern actually formed on a wafer.

At that time, an engineer (user) designates a place which seems to be risky (a risk place), searches a place in an integrated circuit pattern figure corresponding to the risk place, further measures a pattern on the wafer corresponding to the place, or, acquiring the risk place by simulation and the engineer (user) searches a place in the integrated circuit pattern figure corresponding to the risk place and measures a pattern on the wafer corresponding to the place.

To take a step forward, a system in which a place to be measured can be found based on a coordinate value of design data of an integrated circuit pattern has been being developed, hands of engineers are still required for setting a measurement in detail (decision whether the place is a line portion or space portion, measurement direction of a dimension (CD), or the like) at a place to be measured.

In this way, a conventional verification technology needs hands of engineers, and the automation thereof has not been realized.

### BRIEF SUMMARY OF THE INVENTION

According to an aspect of the present invention, there is provided a pattern measuring method comprising: preparing a substrate comprising a pattern; extracting a place to be measured on the substrate based on a simulation using pattern data relating to the pattern as input data; generating measurement information for measuring a physical quantity of the place to be measured by a measuring apparatus; and measuring the place to be measured based on the measurement information by the measuring apparatus.

According to an aspect of the present invention, there is provided a pattern measuring apparatus comprising: an extraction unit configured to extract a place to be measured on a substrate comprising a pattern, the extraction unit including an extraction section configured to extract the place to be measured based on a simulation using pattern data relating to the pattern as input data; a generation unit configured to generate measurement information for measuring a physical quantity of the place to be measured; and a measurement unit configured to measure the place to be measured based on the measurement information.

According to an aspect of the present invention, there is provided a photo mask manufacturing method comprising: judging whether a substrate comprising a pattern is acceptable or rejectable by measuring the substrate, the measuring the substrate comprising the pattern including measuring the substrate comprising the pattern by pattern measuring method according to an aspect of the present invention; setting pattern data relating to the pattern as a final pattern data in a case where the substrate is judged acceptable in the judging whether the substrate is acceptable or rejectable; and renewing the pattern data until the substrate being judged acceptable in a case where the substrate is judged rejectable in the judging whether the substrate is acceptable or rejectable.

According to an aspect of the present invention, there is provided a semiconductor device manufacturing comprising: forming a resist pattern on a substrate including a wafer by a lithography process using a photo mask, the photo mask being manufactured by photo mask manufacturing method according to according to an aspect of present invention; and forming a pattern by etching the substrate using the resist pattern as a mask.

According to an aspect of the present invention, there is provided a computer program product configured to store program instructions for execution on a computer system enabling the computer system to perform: an instruction to read data relating a substrate comprising a pattern; an instruction to extract a place to be measured on the substrate based on a simulation using pattern data relating to the pattern as input data; an instruction to generate measurement information for measuring a physical quantity of the place to be measured by a measuring apparatus; and an instruction to measure the place to be measured based on the measurement information by the measuring apparatus.

### BRIEF DESCRIPTION OF THE SEVERAL VIEWS OF THE DRAWING

FIG. 1 is a flowchart showing a photo mask manufacturing method including a process for verifying mask correction relating to an embodiment of the present invention;

FIG. 2 is a diagram showing a place to be measured in a pattern;

FIG. 3 is marks showing places to be measured;

FIG. 4 is another mark showing a place to be measured;

FIG. 5 is a diagram showing a configuration of step S6;

FIG. 6 is a diagram for explanation of a method for acquiring measurement direction information;

FIG. 7 is a diagram for explanation of a method for acquiring another measurement direction information;

FIG. 8 is a diagram showing a method for determining which of a dimension in the horizontal direction and a dimension in the vertical direction of a space portion is the shorter;

FIG. 9 is marks showing measurement direction information of a space portion;

FIG. 10 is a diagram showing a method for determining which of a dimension in the horizontal direction and a dimension in the vertical direction of a non-space portion is the shorter;

FIG. 11 is marks showing measurement direction information of a non-space portion;

FIG. 12 is a diagram for explanation of a method for acquiring measurement range information in a case of a one-sided finite difference;

FIG. 13 is a diagram for explanation of a method for acquiring measurement range information in a case of a distance of a space interval;

FIG. 14 is marks showing measurement direction information and measurement range information of a non-space portion and a space portion;

FIG. 15 is a diagram schematically showing an apparatus for implementing the photo mask manufacturing method including a method for verifying mask correction of the embodiment;

FIG. 16 is a diagram showing a configuration of mechanisms for generating measurement information on a place to be measured of the apparatus of FIG. 15;

FIG. 17 is a diagram for explanation of a modified example in step S4 of FIG. 1;

FIG. 18 is a mark showing measurement direction information and measurement range information of the modified example; and

FIG. 19 is a diagram for explanation of a computer program product of the embodiment.

### DETAILED DESCRIPTION OF THE INVENTION

Hereinafter, an embodiment of the present invention will be described with reference to the drawings.

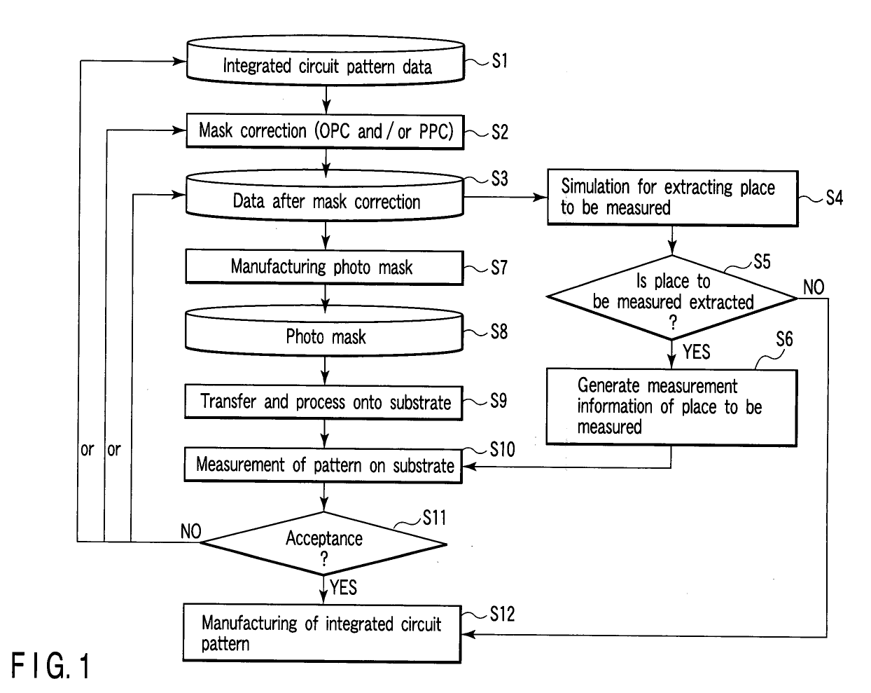

FIG. 1 is a flowchart of a photo mask manufacturing method including a process for verifying mask correction according to an embodiment of the present invention.

The processes of verifying mask correction includes a process for measuring (observing) a place to be measured (a risk place) on a substrate which comprises a pattern by a measuring apparatus, and a process for generating measurement information which is used in measuring the place to be measured by the measuring apparatus.

The substrate is, for example, a Si wafer (semiconductor wafer) or a glass substrate (insulating substrate). The pattern is an integrated circuit pattern. The integrated circuit pattern is, for example, a peripheral circuit pattern of a semiconductor memory such as a DRAM. Further, the pattern is a pattern formed by using a photo mask, or a pattern formed by using electron beam drawing (a direct drawn pattern).

Hereinafter, the details of the photo mask manufacturing method of the present embodiment will be described.

First, data relating to the integrated circuit pattern to be formed on the substrate (integrated circuit pattern data) is prepared (step S1). There is a case that the integrated circuit pattern data is generated in advance, or is newly generated.

Next, a mask correction is applied to the integrated circuit pattern data (step S2), and data including the integrated circuit pattern data and the data relating to the mask correction (data after the mask correction) is generated (step S3). The mask correction is, for example, at least one of an optical proximity correction (OPC) and a process proximity correction (PPC).

Next, a simulation for extracting a place to be measured (a place which will be an object to be verified) is carried out (step S4). The simulation is a well-known simulation using the data after the mask correction (pattern data) as input data. For example, the simulation is generally carried out by a method in which data after mask correction and design data (=data of a pattern having a shape and a dimension which a designer wishes to have on a processing substrate (ideal pattern data)) are compared, and a place (a risk place) having a difference between the both which is greater than or equal to a given value is extracted.

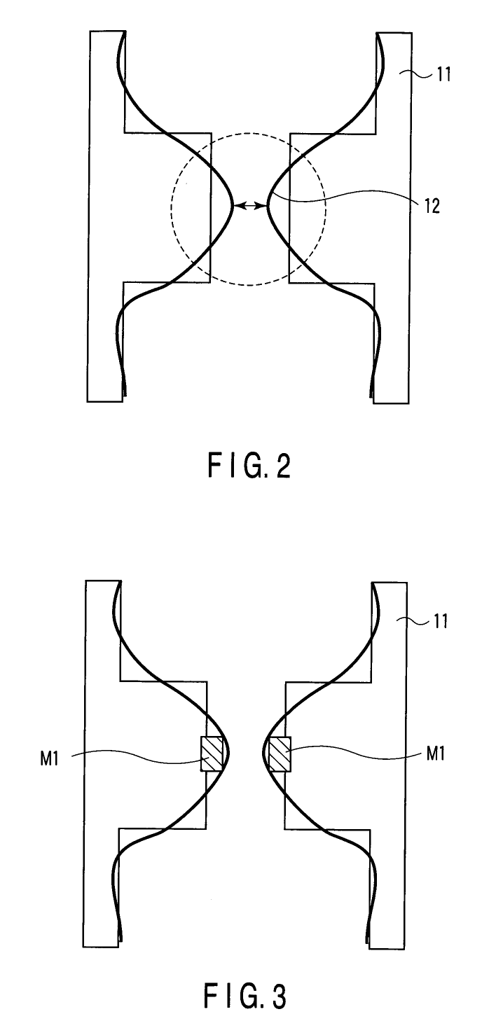

For example, in a case of the pattern of FIG. 2, a region surrounded with a circle of dotted line serves as a place to be measured. In FIG. 2, reference numeral 11 denotes a pattern corresponding to the design data (design pattern), and reference numeral 12 denotes a pattern obtained by a simulation using data after mask correction (simulation pattern).

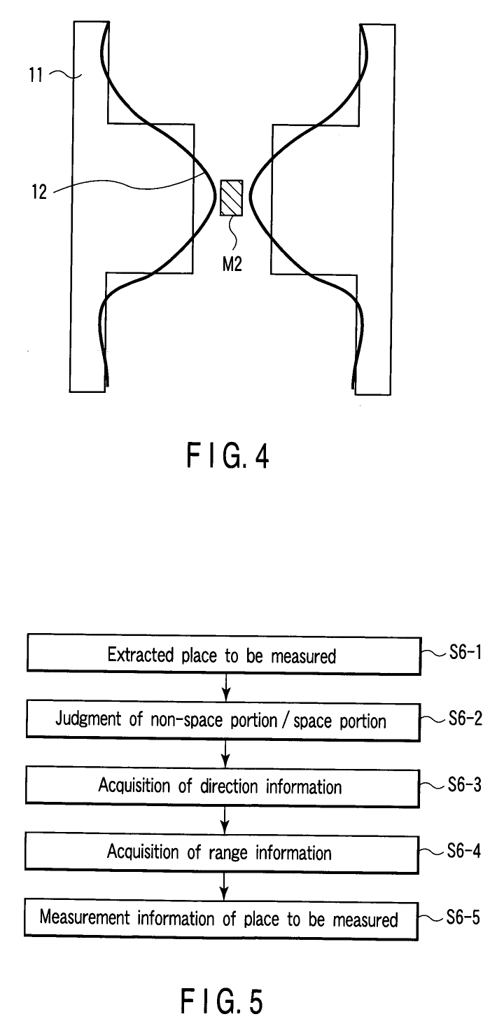

In the present embodiment, it is supposed that a measurement of a pattern is automatically carried out. In a process of measuring a pattern, a process of indicating a place to be measured to an engineer (user) may be included. For example, the place to be measured may be indicated to the engineer (user) by marks M1, M2 as shown in FIG. 3 or FIG. 4. In FIG. 3, parts corresponding to one-sided finite differences are denoted by the marks M1. In FIG. 4, a part corresponding to a space interval is denoted by the mark M2.

A risk place can be indicated by coordinates instead of the marks. In this case, coordinates corresponding to the center of a risk place or coordinates corresponding to the range of a risk place are shown.

In step S4, as standards at the time of extracting a place to be measured, the following standards can be sampled.

(1) As a result of a simulation, for example, a place which is less than or equal to 80% of a minimum dimension allowed in the design (a place which is less than or equal to 80 nm when a minimum dimension is 100 nm) is extracted.

(2) A place whose one-sided finite difference is greater than or equal to 10% of a minimum dimension allowed in the design (a place which is greater than or equal to 10 nm when a minimum dimension is 100 nm) is extracted.

(3) A place which is less than or equal to 80% of a design data dimension at an attention place (attention place dimension) (a place which is less than or equal to 80 nm when the attention place dimension is 100 nm, and a place which is less than or equal to 160 nm when the attention place dimension is 200 nm) is extracted.

(4) A combination of at least two or more of the (1) to (3).

Next, in step S4, it is determined whether or not the place to be measured has been extracted (step S5).

When the place to be measured is not extracted, an integrated circuit pattern is manufactured by using a photo mask for verification used in step S7 which will be described later (step S12).

On the other hand, when the place to be measured is extracted, information (measurement information) utilized at the time of measuring a pattern place on the substrate corresponding to the extracted place by the measuring apparatus is generated (step S6).

A configuration of step S6 is shown in FIG. 5.

First, the place to be measured which is extracted in step S4 is prepared (step S6-1), and it is determined whether the place to be measured is a non-space portion or a space portion (step S6-2).

A non-space portion is a portion other than a space portion in the extracted place to be measured, typically line portion. A determination of non-space portion/space portion can be carried out by a well-known method using a design rule checker or the like.

The reason why the step S6-2 exists is that a threshold value which is set on output of the measuring apparatus differs in the non-space portion and space portion. For example, when the non-space portion is measured, a portion having the output of the measuring apparatus which is more than or equal to A1 is determined as the non-space portion, when the space portion is measured, a portion having the output of the measuring apparatus which is less than or equal to A2 (threshold value 2 (<threshold value 1)) is determined as the space portion.

Next, information relating to a direction for measuring a pattern place on the substrate corresponding to the extracted place (measurement direction information) is acquired (step S6-3).

As a method for acquiring measurement direction information, for example, there are the following methods.

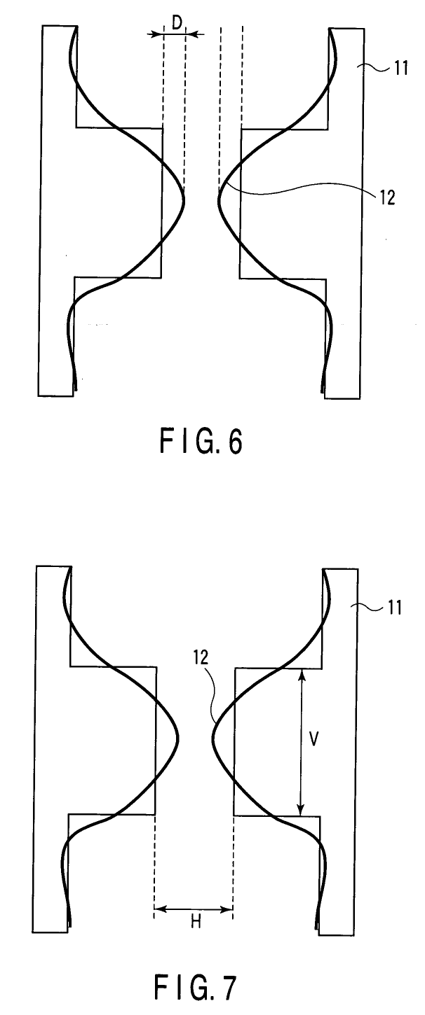

(1) A method in which information of the simulation in step S4 is utilized. For example, as shown in FIG. 6, in a case where the place to be measured is extracted based on the one-sided finite difference D, information relating to a direction for finding the finite difference is determined as the measurement direction information because the direction for finding the finite difference and the direction for measuring is the same.

(2) A method in which a narrowest direction between a vertical direction and a horizontal direction (or an oblique direction) is used as the measurement direction. For example, as shown in FIG. 7, in a case where a dimension H in the horizontal direction is shorter than a dimension V in the vertical direction, information relating to the horizontal direction is determined as the measurement direction information.

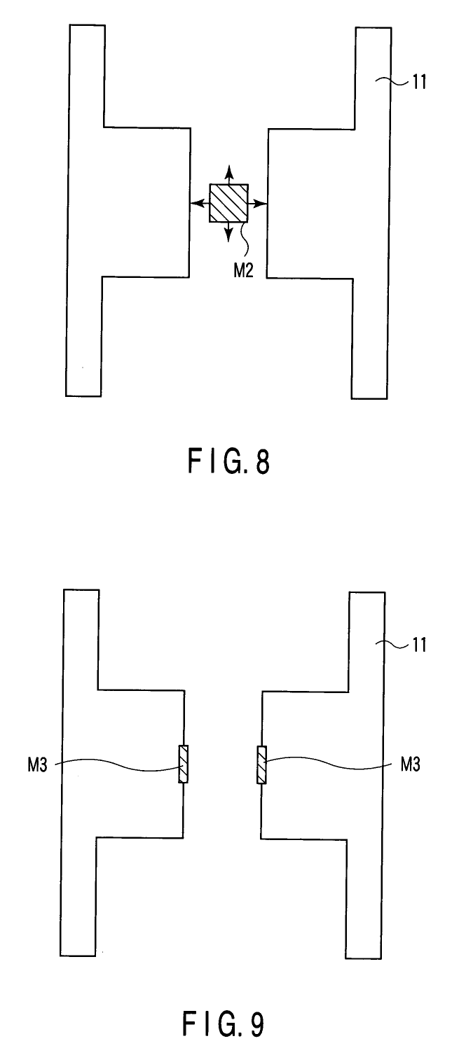

The method for determining which is the shorter between the dimension H in the horizontal direction and the dimension V in the vertical direction is, for example, in a case of the space portion, as in shown in FIG. 8, the mark M2 is enlarged respectively in the horizontal direction and the vertical direction, and it is determined that the direction in which the mark M2 comes into contact with a design pattern 11 first is the shorter direction. If needed, the measurement direction information may be denoted by, for example, marks M3 as shown in FIG. 9.

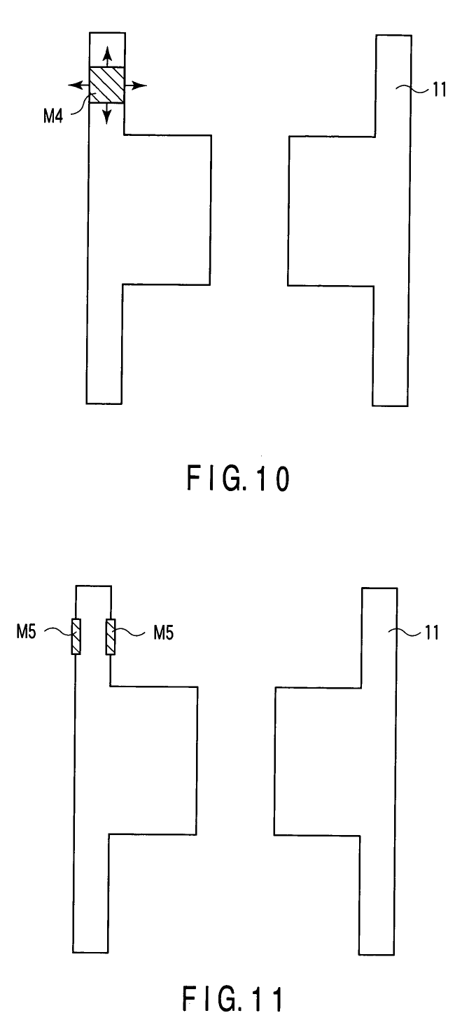

FIGS. 10 and 11 show figures relating to non-space portions (line portions) corresponding to FIGS. 8 and 9. In this case, the measurement direction information is information relating to the width direction of the line portion. M4 is a mark denoting the place to be measured, and M5 are marks denoting measurement direction information.

Next, information relating to a range for measuring the pattern place on the substrate corresponding to the extracted place (measurement range information) is acquired (step S6-4).

As a method for acquiring the measurement range information, for example, the following methods can be considered.

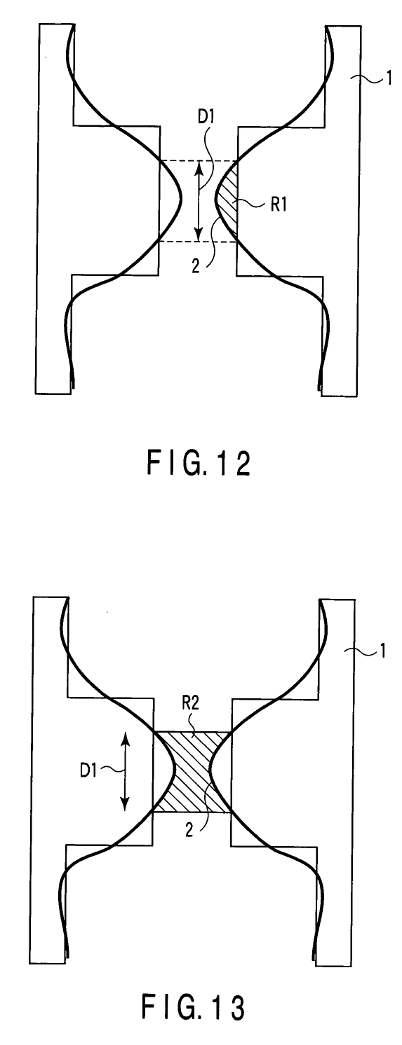

Namely, in a case where the difference between the design pattern and the simulation pattern is the one-sided finite difference, as shown in FIG. 12, information relating to a region R1 having the one-sided finite difference greater than or equal to a setting value (a reference value) or a direction D1 perpendicular to the measurement direction is acquired as the measurement range information. The direction D1 denotes a downward direction or an upward direction.

Further, in a case where a difference between a design pattern and a simulation pattern is a distance of a space interval, as shown in FIG. 13, information relating to a region R2 having a distance of a space interval less than or equal to a set value (a reference value) or a direction D1 perpendicular to a measurement direction is acquired as the measurement range information.

The measurement direction information and measurement range information described above are acquired for each non-space portion and space portion, and information including the measurement direction information and measurement range information of the non-space portion and the space portion are the measurement information of the place to be measured (step S6-5).

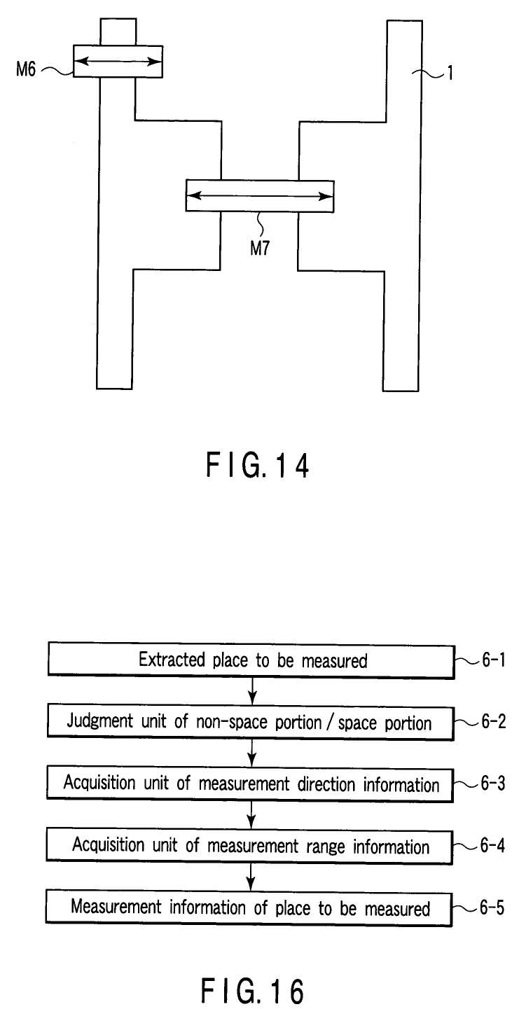

Note that, the measurement direction information and measurement range information of the non-space portion and space portion may be, as needed, as shown in FIG. 14, respectively denoted by separate marks M6 and M7 on one diagram. The mark M6 is a mark denoting the measurement direction information and measurement range information of the non-space portion (line portion). As to the mark M6, the measurement direction information is denoted by an arrow, and the measurement range information is denoted by a range surrounded with a rectangle. In the same way, the mark M7 is a mark denoting the measurement direction information and measurement range information of the space portion, the measurement direction information is denoted by an arrow, and the measurement range information is denoted by a range surrounded with a rectangle.

With respect to the pattern place (place to be measured) on the substrate within a range decided by the measurement range information, at least one of an average dimension, a minimum dimension, a maximum dimension and an area is measured by the measuring apparatus along a direction decided by the measurement direction information.

On the other hand, after mask correction data is generated in step S3, a photo mask for verification is manufactured by using the data after the mask correction (step S7), and the photo mask for verification is prepared (step S8), moreover, a pattern of the photo mask for verification is transferred onto a resist on the substrate, and the substrate is processed (etched) by using the resist as a mask (step S9). As a result, a pattern is formed on the substrate.

Note that, when an integrated circuit pattern is formed on the substrate by using an electron beam drawing, steps S7 and S8 are omitted.

Next, a pattern place on the substrate corresponding to the extracted place is measured by a well-known measuring apparatus (for example, an SEM) (step S10). At that time, the measurement information generated in step S6 is utilized. Accordingly, an instruction to measure the place to be measured on the substrate from which direction, and up to what range is automatically carried out. Namely, the pattern measuring method which can perform automatic pattern measurement is realized.

As the examples of the automatic pattern measurement, there is a method in which the measurement information is inputted into the measuring apparatus, and the measuring apparatus itself determines the measurement direction and measurement range, or a method in which a control device for controlling the measuring apparatus is separately prepared, the measurement information is inputted into the measuring apparatus, and the measurement direction and measurement range of the measuring apparatus are decided by the control device.

Next, it is judged whether or not the pattern on the substrate is acceptable or rejectable (step S11).

In a case Where the pattern on the substrate is judged “acceptance” (good) as a result of the judgment, an integrated circuit pattern is manufactured by using the photo mask for verification used in step S7 (step S12).

On the other hand, in a case where the pattern on the substrate is judged “rejection” (failure) as a result of the judgment in step S11, it returns to step S1 step S2 or step S3, and steps S4 to S10 are carried out, and the judgment in step S11 is carried out. A series of these steps are carried out until the pattern on the substrate is judged “acceptable” in step S11.

Here, an acceptable/rejectable judgment of the pattern on the substrate (step S11) may be automatically carried out. By automating step S11, a photo mask can be manufactured efficiently and at a low cost.

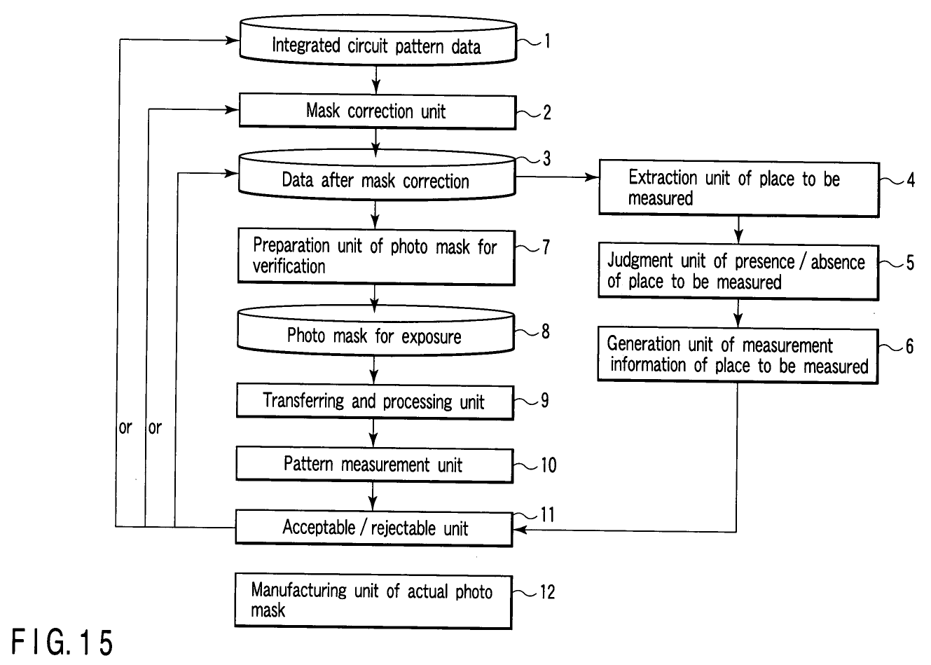

An apparatus for implementing the photo mask manufacturing method including a method for verifying mask correction of the present embodiment is schematically shown in FIG. 15. A configuration of a mechanism 6 for generating measurement information of a place to be measured of the apparatus is shown in FIG. 16.

A mask correction unit 2, extracting unit 4 of a place to be measured, an extracted place measurement information generating unit 6, a verification photo mask preparing unit 7, a transferring and processing unit 9, a pattern measuring unit 10, and an actual photo mask manufacturing unit 12 carry out operations respectively corresponding to processes in steps S2, S4, S6, S7, S9, S10, and S12 of FIG. 1.

In the same way, a non-space unit/space unit judging unit 6-2, a measurement direction information acquiring unit 6-3, and a measurement range information acquiring unit 6-4 carry out operations respectively corresponding to processes in steps S6-2, S6-3 and S6-4 of FIG. 5.

A method including steps S4, S5, S6, and S10 among the steps in the photo mask manufacturing method in the embodiment of FIG. 1 shows the pattern measuring method in the present embodiment. An apparatus including the units 4, 5, 6, and 10 among the mechanisms in the apparatus in the embodiment of FIG. 15 shows the pattern measuring apparatus in the present embodiment.

Next, a semiconductor device manufacturing method of the present embodiment will be described.

The semiconductor device manufacturing method of the present embodiment is a method in which a semiconductor device is manufactured by using a photo mask obtained by the photo mask manufacturing method of the embodiment. To describe concretely, the method is as follows.

First, a resist film is applied on the substrate which includes a semiconductor substrate. The semiconductor substrate is, for example, a silicon substrate or an SOI substrate.

Next, a pattern is drawn on the resist film by using a charged beam drawing apparatus (for example, electron beam drawing apparatus). Thereafter, a resist pattern is formed by developing the resist film.

Next, a pattern is formed on the substrate by etching the substrate using the resist pattern as a mask.

Here, when an underling layer (the uppermost layer of the substrate) of the resist film is a polycrystalline silicon film or metal film, for example, an electrode pattern or a wiring pattern is formed.

In a case where the underling layer of the resist is an insulating film, for example, a fine contact hole pattern or gate insulating film is formed.

In a case where the underling layer of the resist is the semiconductor substrate, for example, an isolation trench (STI) or the like is formed.

The methods of the present embodiment described above can be implemented as a computer program product (for example, a CD-ROM, a DVD) 22 on which a program 21 to be executed by a system including a computer 20 has been recorded.

For example, a computer program product relating to the photo mask manufacturing method of the present embodiment is to make a computer execute steps S1 to S12 (instructions) of FIG. 1 of the present embodiment. Further, a computer program product relating to the pattern measuring method of the present embodiment is to make a computer execute steps S4, S5, S6, and S10 (instructions) of FIG. 1 of the present embodiment.

Note that the present invention is not limited to the above-described embodiment. For example, as the simulation in step S4, the following simulation may be carried out.

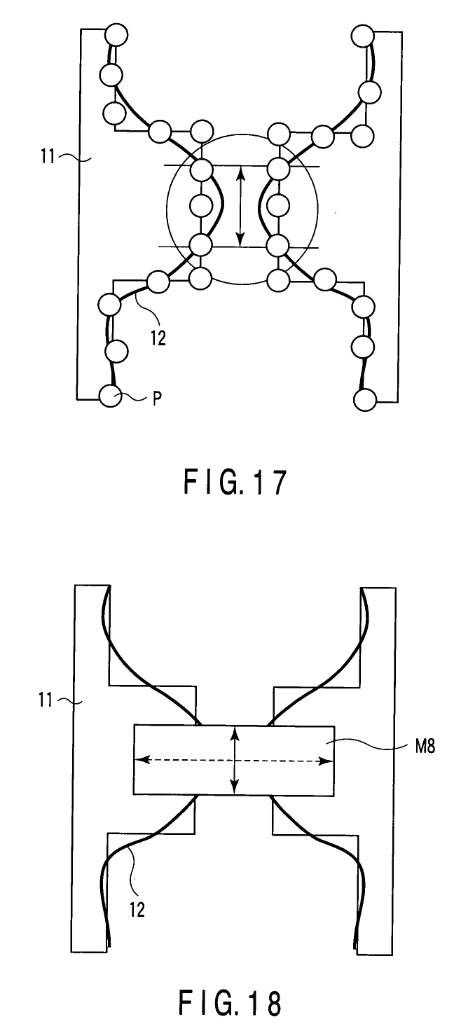

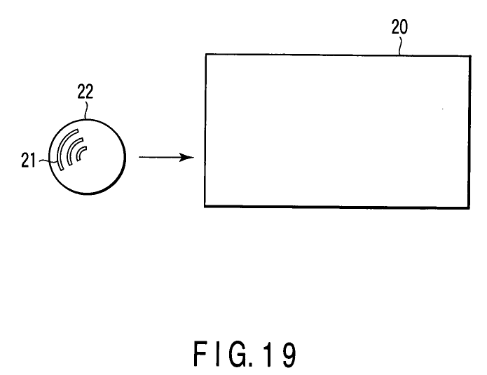

That is, as shown in FIG. 17, a plurality of discrete points (simulation points) P are set on the sides on the design pattern 11, and it is judged whether the points must be measured or not for each point P by comparing a difference between the design pattern 11 and a simulation pattern 12 at each point P and a setting value (reference value). A range including only points judged to be measured is a measurement range. In this case as well, the measurement direction information and measurement range information may be denoted, as needed, by a mark M8 on a drawing as shown in FIG. 18. With respect to the mark M8, the measurement direction information is denoted by a dotted line arrow, and the measurement range information is denoted by a solid line arrow. These arrows are surrounded with a rectangle in order to easy understanding.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A pattern measuring method comprising:
preparing a substrate comprising a pattern;
extracting a place to be measured on the substrate based on a simulation using pattern data relating to the pattern as input data;
generating measurement information for measuring a physical quantity of the place to be measured by a measuring apparatus; and
measuring the place to be measured based on the measurement information by the measuring apparatus.

2. The pattern measuring method according to claim 1, wherein the physical quantity of the place to be measured is a dimension or an area of the pattern.

3. The pattern measuring method according to claim 1, wherein the measurement information for measuring the physical quantity of the place to be measured are information relating to whether the place to be measured is a space portion or not, information relating to a measurement direction when the place to be measured is measured by the measuring apparatus, and information relating to a measurement range when the place to be measured is measured by the measuring apparatus.

4. The pattern measuring method according to claim 2, wherein the measurement information for measuring the physical quantity of the place to be measured are information relating to whether the place to be measured is a space portion or not, information relating to a measurement direction when the place to be measured is measured by the measuring apparatus, and information relating to a measurement range when the place to be measured is measured by the measuring apparatus.

5. The pattern measuring method according to claim 1, wherein the measuring the place to be measured based on the measurement information by the measuring apparatus includes measuring at least one of a minimum dimension, a maximum dimension, an average dimension, and an area of the place to be measured.

6. The pattern measuring method according to claim 2, wherein the measuring the place to be measured based on the measurement information by the measuring apparatus includes measuring at least one of a minimum dimension, a maximum dimension, an average dimension, and an area of the place to be measured.

7. The pattern measuring method according to claim 1, wherein the extracting the place to be measured on the substrate based on the simulation using the pattern data as the input data includes predicting a pattern to be formed on the substrate by a simulation using the pattern data as input data; extracting a place having a difference larger than or equal to a given value as the place to be measured by comparing a physical quantity of a design pattern to be formed on the substrate corresponding to the pattern data and a physical quantity of the predicted pattern, the difference being a difference between the physical quantity of the design pattern and the physical quantity of the predicted pattern.

8. The pattern measuring method according to claim 2, wherein the extracting the place to be measured on the substrate based on the simulation using the pattern data as the input data includes predicting a pattern to be formed on the substrate by a simulation using the pattern data as input data; extracting a place having a difference larger than or equal to a given value as the place to be measured by comparing a physical quantity of a design pattern to be formed on the substrate corresponding to the pattern data and a physical quantity of the predicted pattern, the difference being a difference between the physical quantity of the design pattern and the physical quantity of the predicted pattern.

9. The pattern measuring method according to claim 1, wherein the extracting the place to be measured on the substrate based on the simulation using the pattern data as the input data includes predicting a pattern to be formed on the substrate by a simulation using the pattern data as input data; extracting a place having a difference larger than or equal to a given value as the place to be measured to be measured by comparing a physical quantity of a design pattern to be formed on the substrate corresponding to the pattern data and a physical quantity of the predicted pattern along one direction, the difference being a difference between the physical quantity of the design pattern and the physical quantity of the predicted pattern, and
the generating the measurement information for measuring the physical quantity of the place to be measured by the measuring apparatus includes acquiring information relating to the one direction as information relating to a measurement direction when the place to be measured is measured by the measuring apparatus; and acquiring information relating to a direction perpendicular to the one direction as information relating to a measurement range when the place to be measured is measured by the measuring apparatus.

10. The pattern measuring method according to claim 2, wherein the extracting the place to be measured on the substrate based on the simulation using the pattern data as the input data includes predicting a pattern to be formed on the substrate by a simulation using the pattern data as input data; extracting a place having a difference larger than or equal to a given value as the place to be measured by comparing a physical quantity of a design pattern to be formed on the substrate corresponding to the pattern data and a physical quantity of the predicted pattern along one direction, the difference being a difference between the physical quantity of the design pattern and the physical quantity of the predicted pattern, and
the generating the measurement information for measuring the physical quantity of the place to be measured by the measuring apparatus includes acquiring information relating to the one direction as information relating to a measurement direction when the place to be measured is measured by the measuring apparatus; and acquiring information relating to a direction perpendicular to the one direction as information relating to a measurement range when the place to be measured is measured by the measuring apparatus.

11. The pattern measuring method according to claim 5, wherein the extracting the place to be measured on the substrate based on the simulation using the pattern data as the input data includes predicting a pattern to be formed on the substrate by a simulation using the pattern data as input data; extracting a place having a difference larger than or equal to a given value as the place to be measured by comparing a physical quantity of a design pattern to be formed on the substrate corresponding to the pattern data and a physical quantity of the predicted pattern along one direction, the difference being a difference between the physical quantity of the design pattern and the physical quantity of the predicted pattern, and
the generating the measurement information for measuring the physical quantity of the place to be measured by the measuring apparatus includes acquiring information relating to the one direction as information relating to a measurement direction when the place to be measured is measured by the measuring apparatus; and acquiring information relating to a direction perpendicular to the one direction as information relating to a measurement range when the place to be measured is measured by the measuring apparatus.

12. The pattern measuring method according to claim 6, wherein the extracting the place to be measured on the substrate based on the simulation using the pattern data as the input data includes predicting a pattern to be formed on the substrate by a simulation using the pattern data as input data; extracting a place having a difference larger than or equal to a given value as the place to be measured by comparing a physical quantity of a design pattern to be formed on the substrate corresponding to the pattern data and a physical quantity of the predicted pattern along one direction, the difference being a difference between the physical quantity of the design pattern and the physical quantity of the predicted pattern, and
the generating the measurement information for measuring the physical quantity of the place to be measured by the measuring apparatus includes acquiring information relating to the one direction as information relating to a measurement direction when the place to be measured is measured by the measuring apparatus; and acquiring information relating to a direction perpendicular to the one direction as information relating to a measurement range when the place to be measured is measured by the measuring apparatus.

13. The pattern measuring method according to claim 1, wherein the pattern data relating to the pattern is data to which at least one of an optical proximity correction and a process proximity correction is applied.

14. The pattern measuring method according to claim 2, wherein the pattern data relating to the pattern is data to which at least one of an optical proximity correction and a process proximity correction is applied.

15. The pattern measuring method according to claim 3, wherein the pattern data relating to the pattern is data to which at least one of an optical proximity correction and a process proximity correction is applied.

16. The pattern measuring method according to claim 4, wherein the pattern data relating to the pattern is data to which at least one of an optical proximity correction and a process proximity correction is applied.

17. A pattern measuring apparatus comprising:
an extraction unit configured to extract a place to be measured on a substrate comprising a pattern, the extraction unit including an extraction section configured to extract the place to be measured based on a simulation using pattern data relating to the pattern as input data;
a generation unit configured to generate measurement information for measuring a physical quantity of the place to be measured; and
a measurement unit configured to measure the place to be measured based on the measurement information.

18. A photo mask manufacturing method comprising:
judging whether a substrate comprising a pattern is acceptable or rejectable by measuring the substrate, the measuring the substrate comprising the pattern including measuring the substrate comprising the pattern by pattern measuring method according to claim 1;
setting pattern data relating to the pattern as a final pattern data in a case where the substrate is judged acceptable in the judging whether the substrate is acceptable or rejectable; and
renewing the pattern data until the substrate being judged acceptable in a case where the substrate is judged rejectable in the judging whether the substrate is acceptable or rejectable.

19. A semiconductor device manufacturing method comprising:
forming a resist pattern on a substrate including a wafer by a lithography process using a photo mask, the photo mask being manufactured by photo mask manufacturing method according to claim 18; and
forming a pattern by etching the substrate using the resist pattern as a mask.

20. A computer program product configured to store program instructions for execution on a computer system enabling the computer system to perform:
an instruction to read data relating a substrate comprising a pattern;
an instruction to extract a place to be measured on the substrate based on a simulation using pattern data relating to the pattern as input data;
an instruction to generate measurement information for measuring a physical quantity of the place to be measured by a measuring apparatus; and
an instruction to measure the place to be measured based on the measurement information by the measuring apparatus.
